(19) United States
(12) Patent Application Publication
(10) Pub. No.: US 2018/0322595 A1
(43) Pub. Date: Nov. 8, 2018

(54) NON-TRANSITORY COMPUTER READABLE RECORDING MEDIUM, ITINERARY PLAN SUPPORT METHOD, AND ITINERARY PLAN SUPPORT DEVICE

(71) Applicant: FUJITSU LIMITED, Kawasaki-shi (JP)

(72) Inventors: Akihiro Miyamoto, Minato (JP); Fumito Ito, Kita (JP)

(73) Assignee: FUJITSU LIMITED, Kawasaki-shi (JP)

(21) Appl. No.: 16/026,743

(22) Filed: Jul. 3, 2018

Related U.S. Application Data
(63) Continuation of application No. PCT/JP2016/050170, filed on Jan. 5, 2016.

(51) Int. Cl. G06Q 50/14; G06Q 10/02

(52) U.S. Cl. CPC G06Q 50/14; G06Q 10/025

(57) ABSTRACT

A server executes processing of displaying messages exchanged among members registered in association with an itinerary plan in a chronological order. When the spot information is registered as a message, the server displays the spot information, and displays an instruction manipulation component instructing registration with respect to the itinerary plan on a display unit. The server adds the spot information registered as the message to the itinerary plan, according to an instruction manipulation with respect to the instruction manipulation component.

### CROSS-REFERENCE TO RELATED APPLICATION(S)

This application is a continuation of International Application No. PCT/JP2016/050170, filed on Jan. 5, 2016, the entire contents of which are incorporated herein by reference.

### FIELD

The embodiments discussed herein are related to an itinerary plan support program and the like.

### BACKGROUND

Recently, there have been various conventional technologies of supporting preparation of an itinerary plan. For example, there is a conventional technology in which a spot popular for general users is selected from a plurality of spots relevant to entertainment, sports, culture, and the like in a predetermined area of a travel destination, and a plurality of types of itinerary plans of travelling around the selected spot are generated and are provided to a user.

Here, for example, in the conventional technology described above, it is difficult to prepare an itinerary plan for some users who are interested in a specific field but are not interested in sports or entertainment. In this respect, there is a conventional technology in which a user selects a spot from spots belonging to a specific field, and an itinerary plan including the selected spot is prepared.

Patent Literature 1: Japanese Laid-open Patent Publication No. 2005-107786

Patent Literature 2: Japanese Laid-open Patent Publication No. 2012-008940

Patent Literature 3: Japanese Laid-open Patent Publication No. 2015-018545

Patent Literature 4: Japanese Laid-open Patent Publication No. 2004-177999

However, there is a problem in that in the conventional technology described above, it is not possible to prepare an itinerary plan based on communication among a plurality of users.

### SUMMARY

According to an aspect of an embodiment, a non-transitory computer readable recording medium has stored therein an itinerary plan support program that causes a computer to execute a process including receiving registration of an itinerary plan including one or a plurality of spots; displaying spot information, and an instruction manipulation component instructing registration with respect to the itinerary plan on a display unit, when a program of displaying messages exchanged among members registered in association with the itinerary plan in a chronological order is executed, and the spot information is registered as a message; and adding the spot information registered as the message to the itinerary plan, according to an instruction manipulation with respect to the instruction manipulation component.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a system according to the embodiment;

FIG. 2 is a diagram illustrating a screen example of an itinerary plan which is displayed on a user terminal;

FIG. 3 is a diagram illustrating an example of a chat screen which is displayed on the user terminal;

FIG. 4 is a functional block diagram illustrating a configuration of a server according to the embodiment;

FIG. 5 is a diagram illustrating an example of a data structure of a group table;

FIG. 6 is a diagram illustrating an example of a data structure of a spot table;

FIG. 7 is a diagram illustrating an example of a data structure of an itinerary plan table;

FIG. 8 is a diagram illustrating an example of a data structure of a favorite table;

FIG. 9 is a diagram illustrating a screen example of detailed information of spot information;

FIG. 10 is a flowchart illustrating a processing procedure of the server according to the embodiment; and

FIG. 11 is a diagram illustrating an example of a computer executing an itinerary plan support program.

### DESCRIPTION OF EMBODIMENT(S)

Preferred embodiments of the present invention will be explained with reference to accompanying drawings. Furthermore, the present invention is not limited by such embodiments.

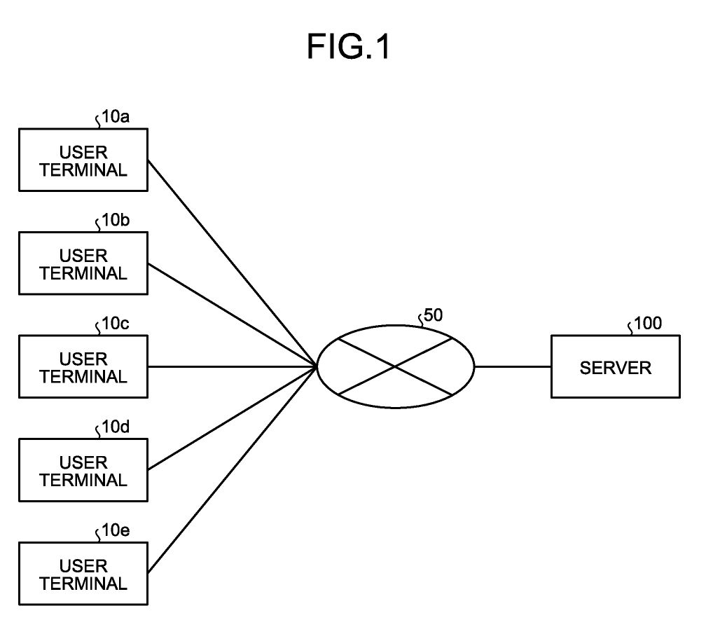

FIG. 1 is a diagram illustrating an example of a system according to this embodiment. As illustrated in FIG. 1, the system includes user terminals 10a, 10b, 10c, 10d, and 10e, and a server 100. The server 100 is an example of an itinerary plan support device.

In FIG. 1, the user terminals 10a to 10e are illustrated, but the system may include other user terminals in addition to the user terminals 10a to 10e. In the following description, the user terminals 10a to 10e will be collectively and suitably referred to as a user terminal 10. The user terminal 10 and the server 100 are connected to each other through a network 50.

The user terminal 10 is a terminal device corresponding to a smart phone, a tablet terminal, a notebook personal computer (PC), or the like, which is used by a user. The user manipulates the user terminal 10, accesses the server 100, and chats with the other user with reference to information of an itinerary plan prepared along with the other user.

The server 100 is a device providing a chat service and a service relevant to preparation of the itinerary plan to the user terminal 10. For example, the server 100 arranges messages transmitted from the user terminal 10 in a chronological order, and notifies information of message strings which are chronologically arranged, to each of the user terminals 10, and thus, provides the chat service to the user terminal 10.

In a case where the information of the itinerary plan is received from each of the user terminals 10 and is registered, and access relevant to the information of the itinerary plan is received from the user terminal 10, the server 100 notifies the information of the itinerary plan, and displays the information of the itinerary plan on the user terminal 10.

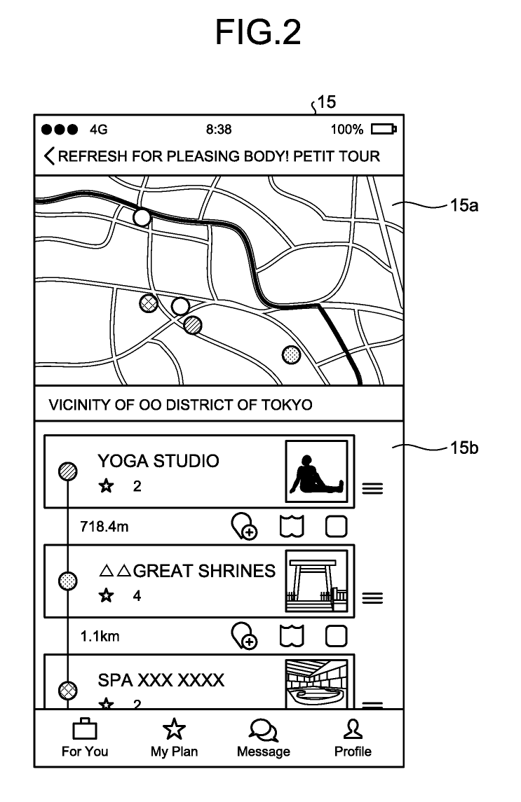

FIG. 2 is a screen example of an itinerary plan which is displayed on a user terminal. As illustrated in FIG. 2, a screen 15 of the itinerary plan includes a map region 15a and an itinerary region 15b. A position of a spot to be traveled in the itinerary plan is displayed in the map region 15a. Information of the spot to be traveled in the itinerary plan is chronologically displayed in the itinerary region 15b. The spot corresponds to a sightseeing spot or a store, leisure facility, or the like.

In addition, in a case where the spot information is registered as a message at the time of providing a chat service, a server 100 displays the spot information on a chat screen, and displays a button of “Add to Plan” of whether or not to register the spot information in the itinerary plan. The server 100 displays a button of “Favorite” of whether or not to register the spot information to a favorite.

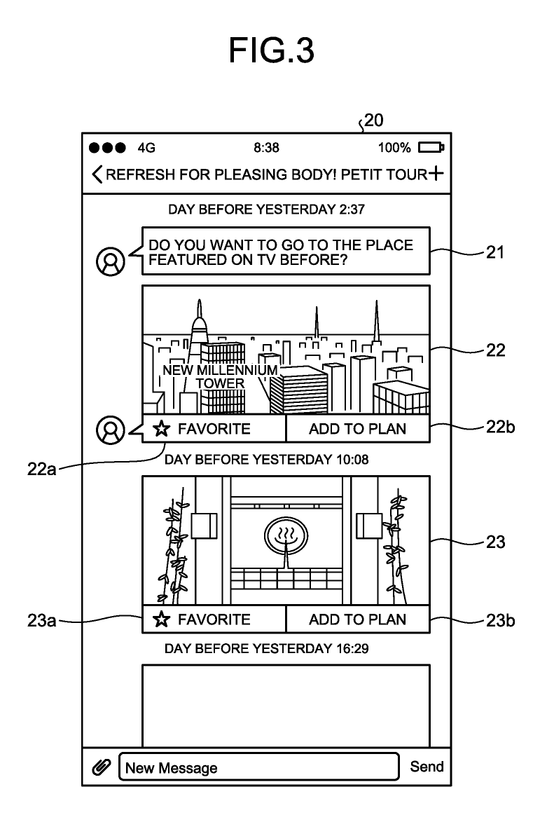

FIG. 3 is a diagram illustrating an example of the chat screen which is displayed on the user terminal. As illustrated in FIG. 3, a chat screen 20 includes a message 21 input by a user, and spot information items 22 and 23 provided by the user. For example, in a case where it is considered that the user wants to add spot information 22 to the itinerary plan, a user terminal 10 is manipulated, and thus, a button 22b of “Add to Plan” is pressed. In a case where it is detected that the button 22b of “Add to Plan” is pressed, the server 100 adds the spot information 22 to the itinerary plan. For example, in a case where new spot information is added to the itinerary plan, the server 100 adds new spot information to the end of the last spot information in the itinerary plan.

In a case where it is considered that the user wants to add the spot information 22 to the favorite, the user terminal 10 is manipulated, and thus, a button 22a of “Favorite” is pressed. In a case where it is detected that the button 22a of “Favorite” is pressed, the server 100 adds the spot information 22 to spot information of the favorite of the user.

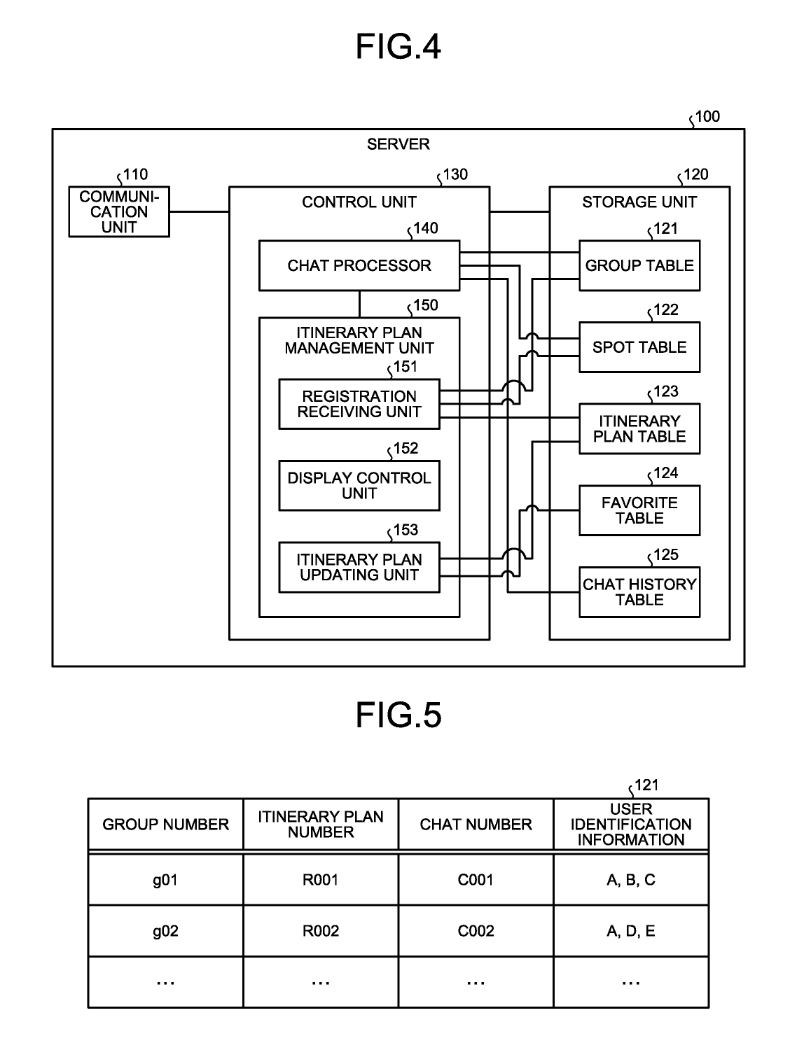

Next, the configuration of the server 100 according to this embodiment will be described. FIG. 4 is a functional block diagram illustrating the configuration of the server according to this embodiment. As illustrated in FIG. 4, the server 100 includes a communication unit 110, a storage unit 120, and a control unit 130.

The communication unit 110 is a processor executing data communication with respect to the user terminal 10 through the network 50. For example, the communication unit 110 corresponds to a communication device. The control unit 130 described below exchanges data with the user terminal 10 through the communication unit 110.

The storage unit 120 includes a group table 121, a spot table 122, an itinerary plan table 123, a favorite table 124, and a chat history table 125. The storage unit 120 corresponds to a storage device such as a semiconductor memory element such as a random access memory (RAM), a read only memory (ROM), and a flash memory, or a hard disk drive (HDD).

The group table 121 is a table of defining a relationship in the itinerary plan, the user joining in the itinerary plan, and the user included in a chat group. FIG. 5 is a diagram illustrating an example of a data structure of the group table. As illustrated in FIG. 5, in the group table 121, a group number, an itinerary plan number, a chat number, and user identification information are associated with each other.

The group number is a number of uniquely identifying a record of the group table 121. The itinerary plan number is a number of uniquely identifying the itinerary plan. The chat number is a number of uniquely identifying the chat group.

The user identification information is information of uniquely identifying the user. For example, the user terminal 10a is manipulated by a user A of user identification information of “A”. The user terminal 10b is manipulated by a user B of user identification information of “B”. The user terminal 10c is manipulated by a user C of user identification information of “C”. The user terminal 10d is manipulated by a user D of user identification information of “D”. The user terminal 10e is manipulated by a user E of user identification information of “E”.

For example, a record of a group number of “g01” of FIG. 5 will be described. A member joining in an itinerary plan number of “R001” is the user A, the user B, and the user C. In addition, a member belonging to a chat group of a chat number of “C001” is the user A, the user B, and the user C.

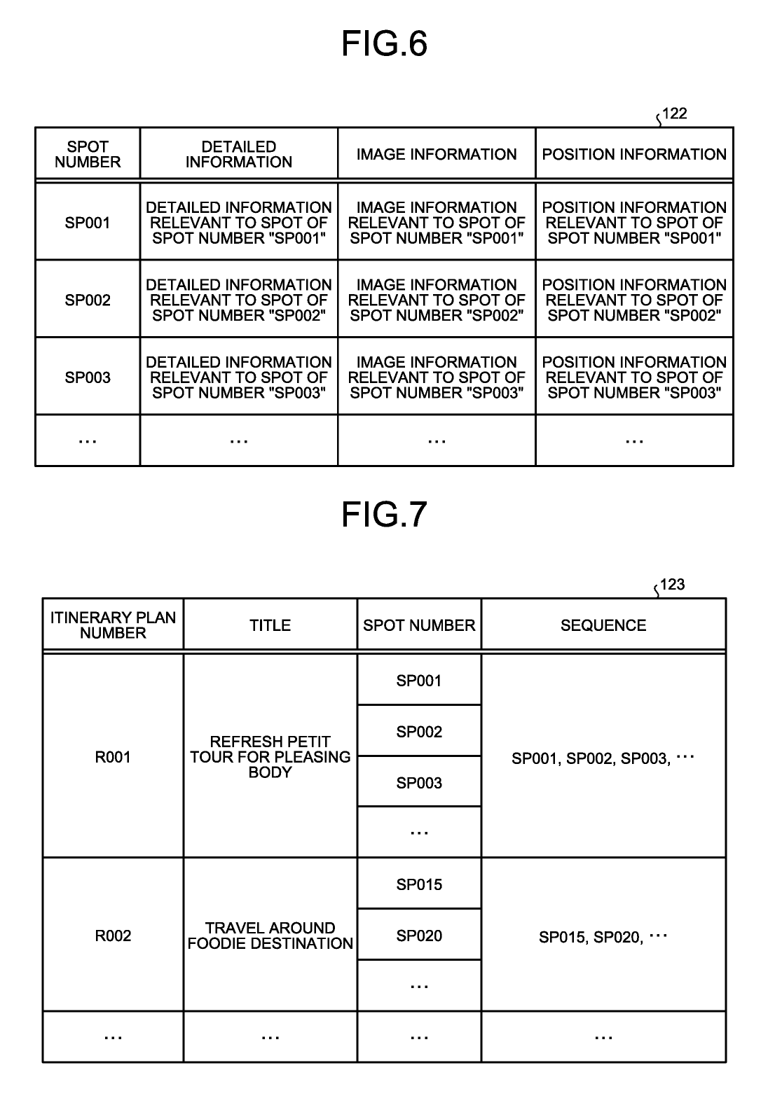

The spot table 122 is a table of retaining spot information. FIG. 6 is a diagram illustrating an example of the data structure of the spot table. As illustrated in FIG. 6, in the spot table 122, a spot number, detailed information, image information, and position information are associated with each other.

The spot number is a number of uniquely identifying the spot information. Furthermore, the spot corresponds to a sightseeing spot or a store, leisure facility, or the like. The detailed information is detailed information of the spot information. For example, the detailed information includes an address, a telephone number, a home page address, an opening hour, a closing day, access information, or the like of the spot. The image information is image information of the spot. The position information is information of position coordinates of the spot.

The itinerary plan table 123 is a table of retaining the information of the itinerary plan. FIG. 7 is a diagram illustrating an example of a data structure of the itinerary plan table. As illustrated in FIG. 7, in the itinerary plan table 123, an itinerary plan number, a title, a spot number, and a sequence are associated with each other. The itinerary plan number is a number of uniquely identifying the itinerary plan. The title is a title of an itinerary plan set by the user. The spot number is a number of uniquely identifying the spot information. The sequence indicates a sequence of the information of the spot to be traveled by the user.

For example, the itinerary plan of the itinerary plan number of “R001” includes spot information corresponding to spot numbers of “SP001, SP002, and SP003”. In addition, the sequence of travelling around the spot is indicated in the order of a spot of “SP001”, a spot of “SP002”, and a spot of “SP003”.

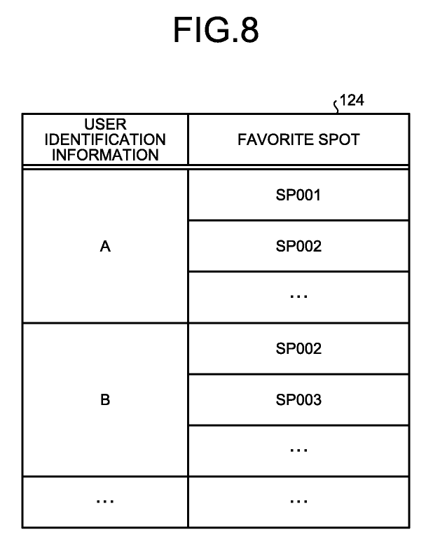

A favorite table 124 is a table of retaining spot information which is the favorite of the user. FIG. 8 is a diagram illustrating an example of a data structure of the favorite table. As illustrated in FIG. 8, in the favorite table 124, user identification information and a favorite spot are associated with each other. The user identification information is information of uniquely identifying the user. The favorite spot is spot information designated by the user as a favorite. For example, the user adds the spot information of the favorite by pressing the button of “Favorite” illustrated in FIG. 3.

A chat history table 125 is a table of retaining the history of the message exchanged among the users.

Return to the description of FIG. 4. The control unit 130 includes a chat processor 140 and an itinerary plan management unit 150. The control unit 130 corresponds to an integrated device such as an application specific integrated circuit (ASIC) or a field programmable gate array (FPGA). In addition, the control unit 130, for example, corresponds to an electronic circuit such as a central processing unit (CPU) or a micro processing unit (MPU).

A chat processor 140 is a processor executing processing relevant to the chat service. The chat processor 140 executes processing of chronologically displaying messages exchanged among members registered in association with the itinerary plan. In addition, the chat processor 140 registers chat history information in the chat history table 125.

Here, the chat processor 140 specifies the member registered in association with the itinerary plan, on the basis of a group table 121. In an example illustrated in FIG. 5, a member registered in association with an itinerary plan number of “R001” is a user A, a user B, and a user C. The chat processor 140 generates a message string in which messages transmitted from user terminals 10a, 10b, and 10c are chronologically arranged, and displays the message string on a screen of the user terminals 10a, 10b, and 10c.

An itinerary plan management unit 150 is a processor which receives access from the user terminal 10, and executes various processings relevant to registration, display, update, or the like of the itinerary plan. The itinerary plan management unit 150 includes a registration receiving unit 151, a display control unit 152, and an itinerary plan updating unit 153.

The registration receiving unit 151 is a processor receiving registration of the itinerary plan including one or a plurality of spot information items. For example, the registration receiving unit 151 receives the information of the itinerary plan from the user terminal 10, and updates the group table 121, the spot table 122, and the itinerary plan table 123, on the basis of the received information.

The information of the itinerary plan received from the user terminal 10 includes information in which the itinerary plan number, the chat number, and the user identification information are associated with each other. The registration receiving unit 151 associates the itinerary plan number, the chat number, and the user identification information with each other, and registers the associated information in the group table 121. Furthermore, the information of the group table 121 may be set in advance.

The information of the itinerary plan received from the user terminal 10 includes information in which the itinerary plan number, the spot number, the title, and the sequence are associated with each other. The registration receiving unit 151 associates the itinerary plan number, the spot number, the title, and the sequence with each other, and registers the associated information in the itinerary plan table 123.

The information of the itinerary plan received from the user terminal 10 includes information in which the spot number, the detailed information, the image information, and the position information are associated with each other. The registration receiving unit 151 associates the spot number, the detailed information, the image information, and the position information with each other, and registers the associated information in the spot table 122.

In a case where the chat processor 140 is executed, and the spot information is registered as a message, the display control unit 152 displays the spot information on the user terminal 10. In addition, in a case where the spot information is displayed, the display control unit 152 displays an instruction manipulation component instructing the registration with respect to the itinerary plan, on a display screen of the user terminal 10.

The processing of the display control unit 152 and the chat processor 140 will be described by using the chat screen 20 described in FIG. 3. In addition, an example, the members exchanging the message are the user A, the user B, and the user C corresponding to the itinerary plan number of “R001”.

In a case where the users A to C manipulate the user terminal 10, and start a chat, the chat processor 140 receives the messages transmitted from the user terminal 10 of the user A, the user B, and the user C. The chat processor 140 chronologically arranges the messages, and allows each of the user terminals 10a, 10b, and 10c to display the chat screen 20. In addition, the users A to C manipulate the user terminal 10 in the middle of the chat, transmit the spot information to the server 100 as a message, and perform a registration request. For example, the registered spot information includes detailed information, image information, and position information. In a case where the registration of the spot information is received, the chat processor 140 assigns a unique spot number to the spot information, associates the spot number, the detailed information, the image information, and the position information with each other, and registers the associated information in the spot table 122.

On the other hand, in a case where the registration of the spot information is received, the display control unit 152 displays the spot information on the chat screen 20 on the display screen of the user terminal 10, and displays a first instruction manipulation component instructing the registration with respect to the itinerary plan. For example, the first instruction manipulation component corresponds to the button of “Add to Plan” illustrated in FIG. 3.

In addition, in a case where the registration of the spot information is received, the display control unit 152 displays a second instruction manipulation component instructing the registration with respect to the favorite, on the chat screen 20. For example, the second instruction manipulation component corresponds to the button of “Favorite” illustrated in FIG. 3.

The itinerary plan updating unit 153 executes processing according to an instruction manipulation with respect to the first instruction manipulation component or the second instruction manipulation component displayed by the display control unit 152.

The processing of the itinerary plan updating unit 153 according to the instruction manipulation with respect to the first instruction manipulation component will be described. The itinerary plan updating unit 153 adds the spot information to the itinerary plan according to the instruction manipulation with respect to the first instruction manipulation component. The processing of the itinerary plan updating unit 153 will be described by using the chat screen 20 described in FIG. 3. In addition, as an example, the members exchanging the message by the chat are the user A, the user B, and the user C corresponding to the itinerary plan number of “R001”.

In a case where anyone user of the users A to C manipulates the user terminal 10, and presses the button 22b of “Add to Plan” of the spot information 22, the user terminal 10 transmits a signal to the effect that the button 22b of “Add to Plan” is pressed, to the itinerary plan updating unit 153. The itinerary plan updating unit 153 receives the signal to the effect that the button 22b of “Add to Plan” is pressed, and thus, determines that the button 22b of “Add to Plan” is pressed, and adds the spot information 22 to an itinerary plan of the itinerary plan number of “R001” in which the users A to C join.

For example, the itinerary plan updating unit 153 accesses the itinerary plan table 123, and adds a spot number of the spot information 22 to a spot number corresponding to the itinerary plan number of “R001”.

In addition, the itinerary plan updating unit 153 adds the added spot number to the end of the line of each spot number represented in sequence of the itinerary plan table 123. For example, a spot number of the spot information 22 added to a record of the itinerary plan number of “R001” is set to “SP022”, and spot numbers stored in sequence are set to “SP001, SP002, and SP003”, respectively. In this case, the itinerary plan updating unit 153 updates sequence information to “SP001, SP002, SP003, and SP022”.

The processing of the itinerary plan updating unit 153 according to the instruction manipulation with respect to the second instruction manipulation component will be described. The itinerary plan updating unit 153 adds the spot information to the favorite table 124, according to the instruction manipulation with respect to the second instruction manipulation component.

For example, a case will be described in which the user A manipulates the user terminal 10a, and the button 22a of “Favorite” of FIG. 3 is pressed. In a case where the user A manipulates the user terminal 10a, and it is detected that the button 22a of “Favorite” is pressed, the itinerary plan updating unit 153 associates user identification information “A” with the spot number of the spot information 22, and registers the associated information in the favorite table 124.

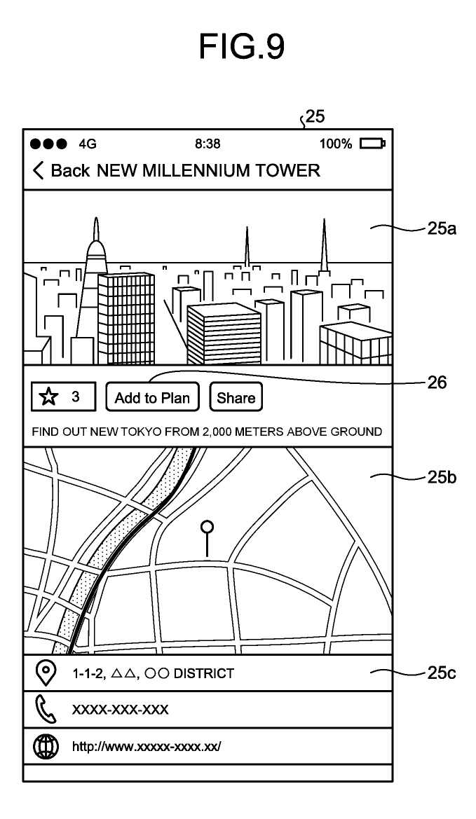

Furthermore, in a case where the spot information is selected on the chat screen 20, the display control unit 152 may display detailed information of the selected spot information on the screen of the user terminal 10. FIG. 9 is a diagram illustrating a screen example of the detailed information of the spot information. As illustrated in FIG. 9, a screen 25 of the detailed information includes an image region 25a, a map region 25b, a detailed information region 25c, and an addition button 26. An image corresponding to the spot information is displayed in the image region 25a. A position of a spot corresponding to the spot information is displayed in the map region 25b. Detailed information corresponding to the spot information is displayed in the detailed information region 25c.

For example, in a case where the spot information is selected, the display control unit 152 compares a spot number of the selected spot information with the spot table 122, and acquires image information, position information, and detailed information corresponding to the spot information. The display control unit 152 arranges the image information, the position information, and the detailed information in the image region 25a, the map region 25b, and the detailed information region 25c, and thus, generates information of the screen 25 of the detailed information, and displays the generated information on the user terminal 10.

In addition, the itinerary plan updating unit 153 determines whether or not the addition button 26 is pressed. In a case where anyone user of the users A to C manipulates the user terminal 10, and presses the addition button 26, the user terminal 10 transmits a signal to the effect that the addition button 26 is pressed, to the itinerary plan updating unit 153. The itinerary plan updating unit 153 receives the signal to the effect that the addition button 26 is pressed, and thus, determines that the addition button 26 is pressed, and adds a spot number corresponding to the spot information of the detailed information to the itinerary plan of the itinerary plan number of “R001” in which the users A to C join.

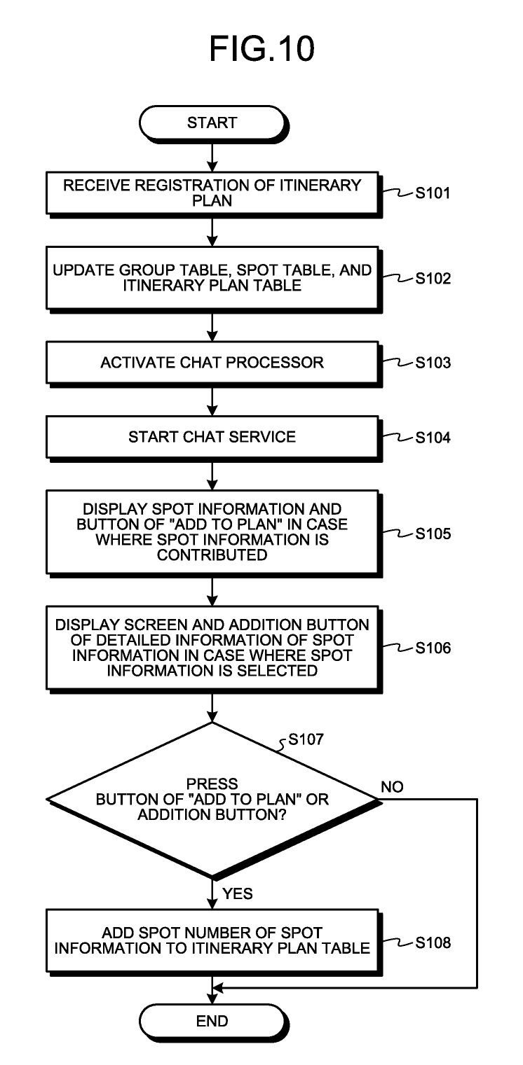

Next, an example of a processing procedure of the server 100 according to this embodiment will be described. FIG. 10 is a flowchart illustrating the processing procedure of the server according to this embodiment. As illustrated in FIG. 10, the itinerary plan management unit 150 of the server 100 receives the registration of the itinerary plan from the user terminal 10 (Step S101). The itinerary plan management unit 150 updates the group table 121, the spot table 122, and the itinerary plan table 123 (Step S102). In a case where an activation request of the chat is received, the itinerary plan management unit 150 activates the chat processor 140 (Step S103).

The chat processor 140 of the server 100 starts the chat service (Step S104). In a case where the spot information is contributed, the chat processor 140 displays the spot information and the button of “Add to Plan” on the chat screen (Step S105).

In a case where the spot information is selected, the itinerary plan management unit 150 displays the screen and the addition button of the detailed information of the spot information (Step S106). The itinerary plan management unit 150 determines whether or not the button of “Add to Plan” or the addition button is pressed (Step S107).

In a case where the button of “Add to Plan” or the addition button is not pressed (Step S107, No), the itinerary plan management unit 150 ends the processing. On the other hand, in a case where the button of “Add to Plan” or the addition button is pressed (Step S107, Yes), the itinerary plan management unit 150 adds the spot number of the spot information to the itinerary plan table 123 (Step S108).

Next, effects of the server 100 according to this embodiment will be described. In a case where the spot information is presented and the button of “Add to Plan” is pressed while a message is exchanged among members joining in the same itinerary plan by using a chat, the server 100 performs the processing of adding the spot information to the itinerary plan. For this reason, the user is capable of suitably adding the spot information proposed while the chat is exchanged, into the itinerary plan, and thus, it is possible to prepare the itinerary plan according to the user.

In a case where the registered spot information is added to the itinerary plan as a message, the server 100 adds the spot information to the end of each of the spot information items of the itinerary plan. Accordingly, it is possible to add new spot information to the itinerary plan while maintaining the sequence of the spot information items generated so far.

In a case where the spot information is contributed while the chat is exchanged, the server 100 displays the button of “Favorite”, and in a case where the button of “Favorite” is pressed, adds the spot information to the favorite table 124. Accordingly, the user is capable of efficiently summarizing the spot information items of the favorite from a plurality of contributed spot information items.

In a case where the spot information is selected on the chat screen, the server 100 displays the detailed information relevant to the spot information along with the addition button, and in a case where the addition button is pressed, adds the corresponding spot information to the itinerary plan. Accordingly, it is possible to add the spot information to the itinerary plan after confirming the detailed information of the spot information.

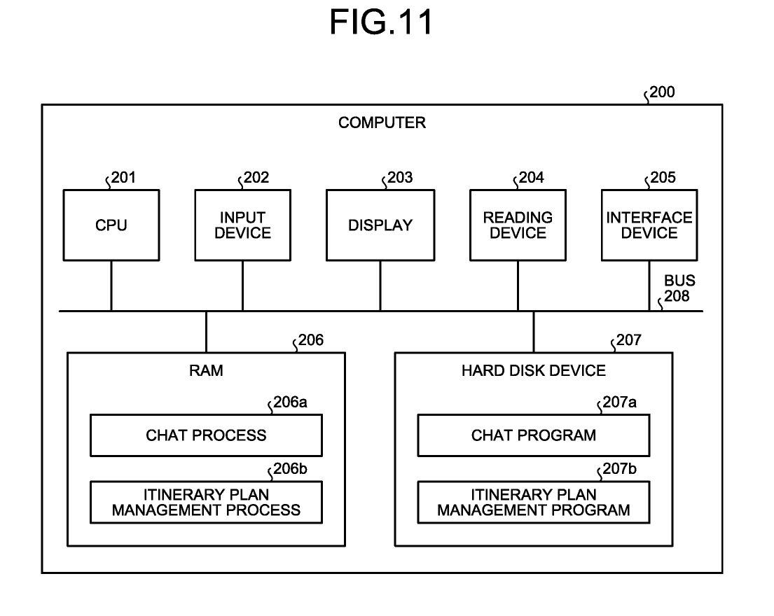

Next, an example of a computer executing an itinerary plan support program of realizing the same function as that of the server 100 described in the embodiment described above will be described. FIG. 11 is a diagram illustrating an example of the computer executing the itinerary plan support program.

As illustrated in FIG. 11, a computer 200 includes a CPU 201 executing various arithmetic processings, an input device 202 receiving input of data from the user, and a display 203. In addition, the computer 200 includes a reading device 204 reading a program or the like from a storage medium, and an interface device 205 performing data delivery with respect to the other computer through a network. In addition, the computer 200 includes a RAM 206 temporarily storing various information items, and a hard disk device 207. Then, each of the devices 201 to 207 is connected to a bus 208.

The hard disk device 207 includes a chat program 207a and an itinerary plan management program 207b. The CPU 201 reads out the chat program 207a and the itinerary plan management program 207b, and decompresses the program in the RAM 206.

A chat program 207a functions as a chat process 206a. An itinerary plan management program 207b functions as an itinerary plan management process 206b.

The processing of the chat process 206a corresponds to the processing of the chat processor 140. The processing of the itinerary plan management process 206b corresponds to the processing of the itinerary plan management unit 150.

Furthermore, it is also preferable that the chat program 207a and the itinerary plan management program 207b are not stored in the hard disk device 207 from the beginning. For example, each of the programs may be stored in a “transportable physical medium” such as a flexible disk (FD), a CD-ROM, a DVD disk, a magnetooptical disk, and an IC card, inserted into the computer 200. Then, the computer 200 may read out and execute each of the programs 207a and 207b.

It is possible to prepare the itinerary plan based on the communication among the plurality of users.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A non-transitory computer readable recording medium having stored therein an itinerary plan support program that causes a computer to execute a process, comprising:
receiving registration of an itinerary plan including one or a plurality of spots;
displaying spot information, and an instruction manipulation component instructing registration with respect to the itinerary plan on a display unit, when a program of displaying messages exchanged among members registered in association with the itinerary plan in a chronological order is executed, and the spot information is registered as a message; and
adding the spot information registered as the message to the itinerary plan, according to an instruction manipulation with respect to the instruction manipulation component.

2. The non-transitory computer readable recording medium according to claim 1, wherein the adding adds the spot information to the end of the last spot of the itinerary plan.

3. The non-transitory computer readable recording medium according to claim 1,
wherein the program of displaying messages displays the spot information and an instruction manipulation component instructing registration with respect to a favorite on the display unit when the spot information is registered as the message, and
the adding adds the spot information registered as the message to the favorite, according to an instruction manipulation with respect to the instruction manipulation component.

4. The non-transitory computer readable recording medium according to claim 1,
wherein the displaying displays detailed information of the spot information and a second instruction manipulation component instructing registration with respect to the itinerary plan on the display unit when the displayed spot information is selected, and
the adding adds the spot information registered as the message to the itinerary plan, according to an instruction manipulation with respect to the second instruction manipulation component.

5. An itinerary plan support method comprising:
receiving registration of an itinerary plan including one or a plurality of spots, using a processor;
displaying spot information, and an instruction manipulation component instructing registration with respect to the itinerary plan on a display unit, when a program of displaying messages exchanged among members registered in association with the itinerary plan in a chronological order is executed, and the spot information is registered as a message, using the processor; and
adding the spot information registered as the message to the itinerary plan, according to an instruction manipulation with respect to the instruction manipulation component using the processor.

6. The itinerary plan support method according to claim 5, wherein the adding adds the spot information to the end of the last spot of the itinerary plan.

7. The itinerary plan support method according to claim 5,
wherein the program of displaying messages displays the spot information and an instruction manipulation component instructing registration with respect to a favorite on the display unit when the spot information is registered as the message, and
the adding adds the spot information registered as the message to the favorite, according to an instruction manipulation with respect to the instruction manipulation component.

8. The itinerary plan support method according to claim 5,
wherein the displaying displays detailed information of the spot information and a second instruction manipulation component instructing registration with respect to the itinerary plan on the display unit when the displayed spot information is selected, and
the adding adds the spot information registered as the message to the itinerary plan, according to an instruction manipulation with respect to the second instruction manipulation component.

9. An itinerary plan support device, comprising:
a processor that executes a process comprising:
receiving registration of an itinerary plan including one or a plurality of spots;
displaying spot information, and an instruction manipulation component instructing registration with respect to the itinerary plan on a display unit, when a program of displaying messages exchanged among members registered in association with the itinerary plan in a chronological order is executed, and the spot information is registered as a message; and
adding the spot information registered as the message to the itinerary plan, according to an instruction manipulation with respect to the instruction manipulation component.

10. The itinerary plan support device according to claim 9, wherein the adding adds the spot information to the end of the last spot of the itinerary plan.

11. The itinerary plan support device according to claim 9,
wherein the program of displaying messages displays the spot information and an instruction manipulation component instructing registration with respect to a favorite on the display unit when the spot information is registered as the message, and
the adding adds the spot information registered as the message to the favorite, according to an instruction manipulation with respect to the instruction manipulation component.

12. The itinerary plan support device according to claim 9,
wherein the displaying displays detailed information of the spot information and a second instruction manipulation component instructing registration with respect to the itinerary plan on the display unit when the displayed spot information is selected, and
the adding adds the spot information registered as the message to the itinerary plan, according to an instruction manipulation with respect to the second instruction manipulation component.
